(19) United States
(12) Patent Application Publication
(10) Pub. No.: US 2006/0142166 A1
(43) Pub. Date: Jun. 29, 2006

(54) Method using particulate chelates to stimulate production of petroleum in carbonate formations

(76) Inventor: Ronnie L. Thomas, Tulsa, OK (US)

Correspondence Address: ABELMAN, FRAYNE & SCHWAB, 666 THIRD AVENUE, 10TH FLOOR, NEW YORK, NY, 10017, US

(21) Appl. No.: 10/533,821

(22) PCT Filed: Nov. 17, 2003
(86) PCT No.: PCT/US03/36906

§ 371 Date: Jan. 6, 2006

Related U.S. Application Data
(60) Provisional application No. 60/427,135, filed on Nov. 18, 2002.

(51) Int. Cl. E21B 43/00; C09K 8/00

(52) U.S. Cl. 507/267

(57) ABSTRACT

A method and composition for stimulating petroleum production from carbonate reservoirs by employing chelating agents, such as EDTA, which are in particulate form rather than aqueous solutions of chelating agents. The use of particulate chelants, which are relatively unstable in acidic solutions, results in a stimulation fluid with a very high dissolution capability.

### CROSS-REFERENCE TO RELATED APPLICATIONS

This application claims the priority benefits of provisional application Ser. No. 60/427,135, which was filed on Nov. 18, 2002, the disclosure of which is incorporated by reference.

### FIELD OF THE INVENTION

This invention relates generally to a process for the stimulation of petroleum production from carbonate reservoirs and, more particularly, to a process for stimulating petroleum production by the use of certain types of chelating agents.

### BACKGROUND OF THE INVENTION

The production of hydrocarbons, such as natural gas, oil, etc., which are located in subterranean reservoirs is typically accomplished by allowing the hydrocarbon in the matrix of the rock to flow into a wellbore and, subsequently, to the surface. This process is normally impeded by damage to the underground formation created during the drilling and completion process. The flow of hydrocarbon is normally improved via a process referred to as “stimulation”.

Stimulation, as that term is understood in the petroleum industry, is a method of improving hydrocarbon flow by the use of matrix acidizing or acid fracturing techniques. Matrix acidizing is a technique which has been used extensively since the 1930's, primarily to improve the production from oil and gas wells, although it has also been used to improve injection. A fluid, either an acid or a solvent, is injected below the fracturing pressure of the reservoir to produce a radial flow around the wellbore. The classical goal of sandstone matrix acidizing is to restore the natural permeability of the reservoir by removing the formation damage caused during uniform radial flow. The formation damage, such as the presence of drilling mud, scale, etc., which serves to plug the pores can be dissolved to yield improved matrix flow which approaches the natural flow capacity of the undamaged well.

Carbonate matrix acidizing treatments are designed to bypass the damage via the creation of radial wormholes in order to yield a high permeability region around the wellbore, which exceeds the natural permeability of the reservoir. This is true reservoir stimulation as observed in a hydraulically fractured well, e.g., a negative skin is created to yield higher production then is normally obtained from an undamaged producer under the same drawdown conditions.

Acid fracturing is performed on carbonate reservoirs. This involves the injection of fluids, including acid, into the well at pressures sufficient to fracture the formation, thereby creating a large flow channel through which hydrocarbons can readily move from the formation in the wellbore.

During both matrix acidizing and acid fracturing, it is desirable for the acid to penetrate deeply into the reservoir. As a result, retarded hydrochloric acid systems have been developed to achieve deeper live acid penetration. Exemplary of such systems are chemically retarded acids, encapsulated acids and emulsified acids.

Although the use of retarded acids serve to improve live acid penetration into the reservoir, they have certain disadvantages. For example, hydrochloric acid can destabilize asphaltenes which are present in crude to form an insoluble sludge. Furthermore, hydrochloric acid is extremely corrosive, especially in those instances where Super 13 Cr hardware is employed.

While the use of “chelants” and “chelating agents”, such as EDTA and H₄ EDTA have been reported in the literature, it has also been reported that they create wormholes in limestone and dolomite reservoirs when pumped in as aqueous solutions.

### SUMMARY OF THE INVENTION

It has now been found that the problems attendant the prior art use of aqueous solutions of chelating agents can be overcome by using a “chelant” or “chelating agent” which is in particulate form rather than the aqueous chelating solutions disclosed in the prior art. The use of particulate chelants yields deeper stimulation in both matrix acidizing and acid fracturing, and also serves to dissolve calcareous scale found in the drilling mud filter cake, resulting in enhanced hydrocarbon production. The particulates dissolve as the chelant in solution reacts with the limestone/dolomite.

Using a chelating agent in particulate form, in accordance with the process of the present invention, avoids the need for the use of retarded HCl systems which results in acid corrosion of hardware, destabilization of asphaltenes present in the crude and in the formation of an insoluble sludge. These chelants have a low level of stability in acidic solution which serves to create a stimulation fluid with a very high dissolution capability.

### BRIEF DESCRIPTION OF THE DRAWING

The figure of a graph showing the moles of calcium carbonate powder per liter dissolved at pH 0, 2.9 and 3 when mixed with 0.21 moles of particulate EDTA liter at 150° F. for four hours.

### DETAILED DESCRIPTION OF THE INVENTION

Various types of chelating agents can be employed in the process of the present invention. Examples of preferred chelating agents are ethylene diamine tetracetic acid (EDTA), hydroxyethyl ethylene diamine tetracetic acid (HEDTA), hydroxy ethyl imino diacetic acid (HEIDA), diethylene triamine pentacetic acid (DTPA), 1,2-cyclohexanediaminetetracetic acid (CDTA), and mixtures thereof. The chelant can be in the form of a free acid, or in the form of its sodium, potassium, calcium or ammonium salt.

Since it is known that chelating agents can create wormholes in limestone and dolomite reservoirs when pumped in as an aqueous solution, and since it is also known that chelating agents, such as EDTA, are only 0.4 wt % soluble in 28 wt % HCl, the use of a chelating agent such as EDTA in particulate form, with either an ungelled, gelled and/or emulsified acid, such as, for example, hydrochloric, acetic or formic acids, serves to penetrate deeper into the tip of a wormhole prior to dissolving. Furthermore, once dissolution occurs, deeper wormholes are created to yield improved stimulation results.

The composition of the present invention is referred to herein as a “well treatment fluid composition”. It comprises a chelating agent in particulate form, or a salt thereof, as well as water. The quantity of the chelating agent can be in the range of from about 0.1 to about 2.0 moles liter, but preferably is between about 0.1 to about 1 mole/liter of the well treatment fluid composition. Optionally, the well treatment fluid composition can also include a variety of additives including, but not limited to, a corrosion inhibitor, a gelling agent, a wetting agent, an emulsifier, a solvent, a pH adjusting chemical, an inorganic fluoride salt, a diverting agent, a chemical retardant, a fluid loss additive or mixtures thereof.

When particulate EDTA or a salt thereof is employed as the chelating agent, the pH of the well treatment fluid composition can be in the pH range of about 0 to about 2.9. When other particulate chelating agents are employed, such as HEDTA, DTPA and CDTA, the pH range can be from about 0 to about 7.

The well treatment fluid composition is injected through the wellbore into a subterranean formation at elevated pressure, preferably between about 14 psi to about 20,000 psi. The temperature of the subterranean formation during injection is preferably between about 100° F. and about 400° F.

Optionally, the well treatment fluid can contain from about 1% to about 20%, by volume, of an organic acid, such as formic acid or acetic acid.

Still another available option would be to add about 1% to about 36 wt % of hydrochloric acid to the well treatment fluid composition.

The present invention can be further understood from the following examples.

### EXAMPLE 1

The following demonstrates the ability of particulate EDTA to dissolve calcium carbonate (limestone). In this example, 23.76 g of tetrasodium EDTA tetrahydrate was added to 200 ml of distilled water at room temperature. Thirty-six (36) wt % HCl was then added while stirring vigorously until the EDTA precipitated at pH 0, pH 2.9 and pH 3.0, respectively.

Distilled water and HCl were then added until the volume was 250 ml to yield 0.21 moles of EDTA per liter and the test pH.

The fluids were then heated to a temperature of 150° F. with the pH at this point being approximately 2.7.

Then 6.26 g of powdered calcium carbonate was added to the EDTA system while stirring. The pH increased to about 4.5 to 5 following the addition of the calcium carbonate. Stirring was maintained for a period of four hours. Subsequently, the solution was filtered and the solids were dried in an oven. It should be noted that when the EDTA systems at pH 0 and pH 2.9 were inspected, there were slurries of precipitated EDTA. By contrast, when the system at a pH of 3.0 was inspected, it exhibited only slight precipitation of EDTA.

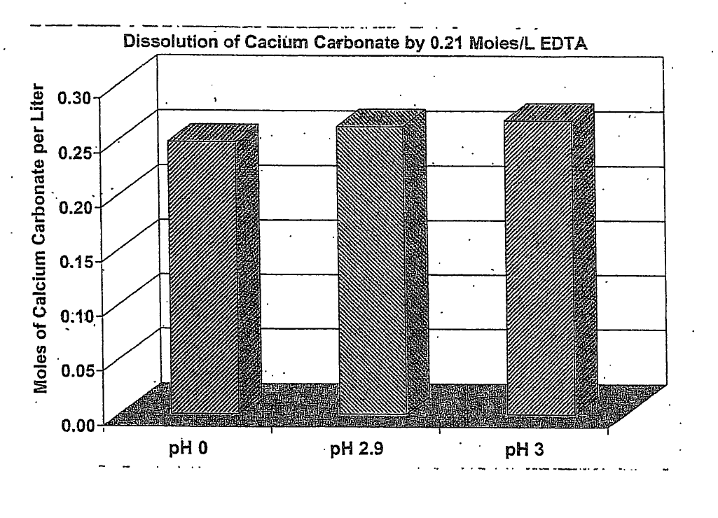

FIG. 1 shows the moles of calcium carbonate powder per liter dissolved at pH 0, 2.9 and 3 when mixed with 0.21 moles of EDTA per liter at 150° F. for four hours. Theoretically, one mole of calcium carbonate will react with one mole of EDTA as shown in the following equation.
H₄ EDTA_{solid}+H₂O⇄H₂EDTA⁻²+2H+CaCO₃⇄Ca⁺²+H₂CO₃+H₂EDTA⁻²⇄CaH₂EDTA+H₂CO₃

However, the average moles of calcium carbonate actually dissolved is 0.24 moles, which is indicative of a higher reaction yield. Note should be taken that at a pH of 2.9, the yield was 125%. It is also interesting to observe that at pH 3, the quantity of calcium carbonate dissolved resulted in a substantially clear liquid with the majority of the EDTA dissolved, while at a pH of 2.9, there was a slurry of particulate EDTA. Thus, the slurried EDTA can be used to dissolve calcium carbonate.

### EXAMPLE 2

The following demonstrates the ability of particulate EDTA to dissolve calcium carbonate (limestone). A 0.21 M EDTA slurry was prepared in accordance with Example 1 at room temperature to produce a pH of 2.9, by adding 36 wt % HCl to a solution of EDTA at a pH of 12. The EDTA slurry at pH 2.9 had a cloudy, opaque appearance. The slurry was then heated to a temperature of 150° F. while stirring was maintained. The pH at this point was approximately 2.5.

Thereafter, a limestone field core was suspended in the slurry, and stirring was maintained for a period of four (4) hours. The solution was then filtered and the core was dried in an oven.

The particulate EDTA slurry was heated to 150° F. to simulate injection into a well. The appearance of the solution was examined at T=0 hours, T=1 hour, and T=2 hours. The appearance of the solution at T=0 hours while still somewhat opaque was less so than the appearance at room temperature and pH 2.9 described above. At T=1 hour, the fluid contained a lesser quantity of particulate EDTA, and it had a slightly brown coloration. At T=2 hours, the appearance of the solution became clear, which is indicative of complete dissolution of the particulate EDTA.

What is claimed is:

1. A well treatment fluid composition, comprising:
water and a chelant in particulate form or a salt thereof.

2. The composition of claim 1, wherein the chelant is selected from the group consisting of:
ethylenediaminetetraacetic acid (EDTA), hydroxyethylethylenediaminetracetic acid (HEDTA), hydroxyethyliminodiacetic acid (HEIDA), diethylenetriaminepentaacetic acid (DTPA), 1,2-cyclohexanediaminetetraacetic acid (CDTA), the salts thereof, and mixtures thereof.

3. The composition of claim 2, wherein the chelant is selected from a free acid, a sodium salt, a potassium salt, and an ammonium salt.

4. The composition of claim 1, and including an acid selected from the group consisting of hydrochloric, acetic, and formic acids, and mixtures thereof.

5. The composition of claim 1, wherein the chelant comprises from about 0.1 to 2 mole per liter of the composition.

6. The composition of claim 1, wherein the particulate chelant is suspended in the solution.

7. The composition of claim 1, further comprising a corrosion inhibitor wherein the corrosion inhibitor comprises a quaternary ammonium compound and at least one of an unsaturated oxygen compound or a reduced sulfur compound.

8. The composition of claim 1, further comprising an additive selected from the group consisting of a gelling agent, a wetting agent, an emulsifier, an agent preventing the formation of an emulsion, a solvent, a pH adjustment chemical, an inorganic fluoride salt, a diverting agent, a fluid loss additive, a chemical retarder, and mixtures thereof.

9. The composition of claim 2, wherein the pH is from about 0 to about 2.9 when EDTA is employed as the chelant.

10. A method of treating a subterranean formation, comprising:
injecting a well treatment fluid composition comprising a particulate chelant or a salt thereof and water via a wellbore into a subterranean formation.

11. The method of claim 10, wherein the particulate chelant is selected from the group consisting of:
ethylenediaminetetraacetic acid (EDTA), hydroxyethylethylenediaminetracetic acid (HEDTA), hydroxyethyliminodiacetic acid (HEIDA), diethylenetriaminepentaacetic acid (DTPA), 1,2-cyclohexanediaminetetraacetic acid (CDTA), or mixtures thereof.

12. The method of claim 11, wherein the chelant is selected from a free acid, a sodium salt, a potassium salt, or an ammonium salt.

13. The method of claim 12, wherein the chelant comprises from about 0.1 moles per liter to about 2 moles per liter.

14. The method of claim 10, wherein the particulate chelant is suspended in the solution.

15. The method of claim 10, wherein the fluid also includes an acid selected from the group consisting of hydrochloric, acetic, and formic acids, and mixtures thereof.

16. The method of claim 11, wherein the composition further comprises an additive selected from a corrosion inhibitor, gelling agent, wetting agent, an emulsifier, an agent preventing the formation of an emulsion, a solvent, a pH adjustment chemical, an inorganic fluoride salt, a diverting agent, a fluid loss additive, a chemical retarder, and mixtures thereof.

16. The method of claim 9, wherein the fluid is injected below a pressure to exceed the minimum horizontal stress (the fracturing pressure).

17. The method of claim 10, wherein the process is repeated during the treatment.

18. The method of claim 11, wherein the pH is from about 0 to about 2.9 when EDTA is employed as the chelant.

19. The method of claim 10, wherein the injection is performed at a pressure from about 14 psi to about 20,000 psi.

20. The method of claim 16, wherein the pH adjustment chemical is selected from the group consisting of an organic acid, a mineral acid, and a base.

21. The method of claim 10, wherein the formation is at a temperature from about 100° F. to about 400° F.
